(19) United States
(12) Patent Application Publication
(10) Pub. No.: US 2016/0124695 A1
(43) Pub. Date: May 5, 2016

(54) NETWORK VISUALIZATION SYSTEM AND METHOD

(71) Applicant: Ciena Corporation, Hanover, MD (US)

(72) Inventor: Jason Kane, Santa Rosa, CA (US)

(21) Appl. No.: 14/533,926

(22) Filed: Nov. 5, 2014

(51) Int. Cl. G06F 3/14; H04L 12/24; G06F 3/0482; G06F 3/0484

(52) U.S. Cl. CPC G06F 3/14; G06F 3/04842; H04L 41/22; G06F 3/0482

(57) ABSTRACT

A graphical user interface represents a plurality of nodes in an interface as a minimum convex hull (MCH) encompassing geographic locations of the nodes. Polygons corresponding the MCHs of networks for various markets are stored for later use. Upon receiving an instruction to display a market on a map, the polygon representing the network is retrieved and rendered thereby providing a computationally inexpensive display of the extent of the network. Upon selection of the polygon, polygons for MCHs of sub-markets may be displayed. Display of a polygon for a market may be accompanied with metadata representing a status of the nodes of the network. A polygon representing a market may be shaded in order to reflect a concentration of nodes within the polygon.

### FIELD OF THE INVENTION

This invention relates to systems and methods for providing a graphical representations of complex network environments.

### BACKGROUND OF THE INVENTION

Modern networks can be very complex. For example, a large corporation or organization with a large number of interconnected facilities may include a very large number of interconnected devices (hereinafter “nodes”). It can be difficult to visualize such a network. A high-level view of the network may include too much information and be useless for understanding the network as well as require a large amount of processing to render.

Algorithms exist to view information in different levels of details. For example, different amounts of detail may be displayed for different views. Some map viewing applications allow one to view maps with different levels of details of a region by zooming in or out of the region.

This application is directed to an improved algorithm for visualizing large networks with different levels of detail.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a computer system suitable for implementing methods in accordance with embodiments of the invention;

FIG. 2 is schematic block diagram of a network environment suitable for visualization in accordance with embodiments of the present invention;

FIG. 3 is a schematic diagram of a user interface in accordance with an embodiment of the present invention;

FIG. 4 is a schematic diagram of a second user interface in accordance with an embodiment of the present invention;

FIG. 5 is a schematic diagram of a third user interface in accordance with an embodiment of the present invention;

FIG. 6 is a schematic diagram of a fourth user interface in accordance with an embodiment of the present invention; and

FIG. 7 is a process flow diagram of a method for generating and updating an interface in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for visualizing a network spanning a large geographical area.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

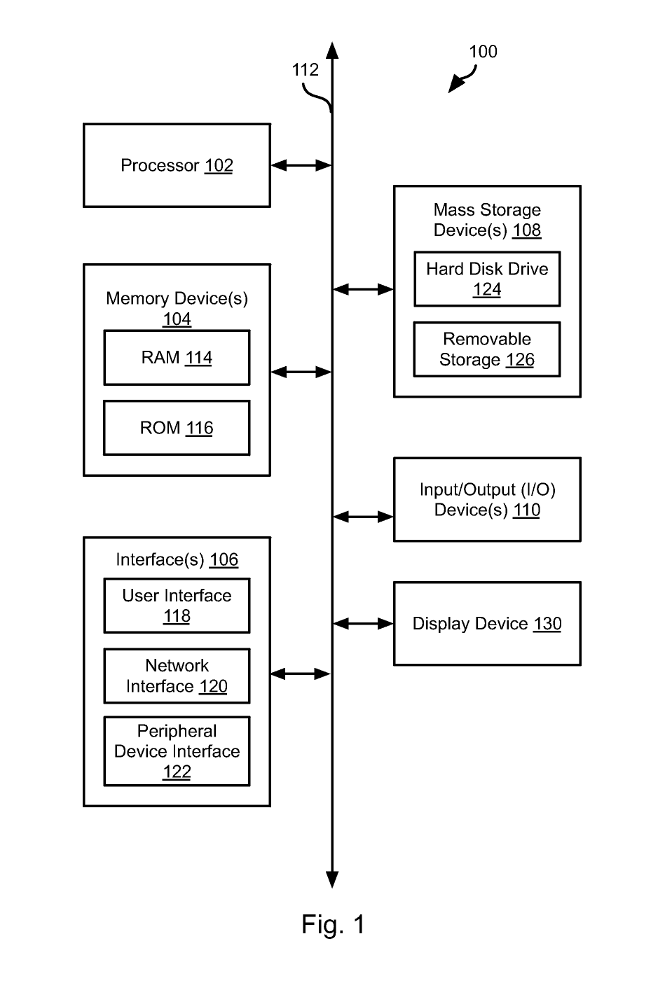

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

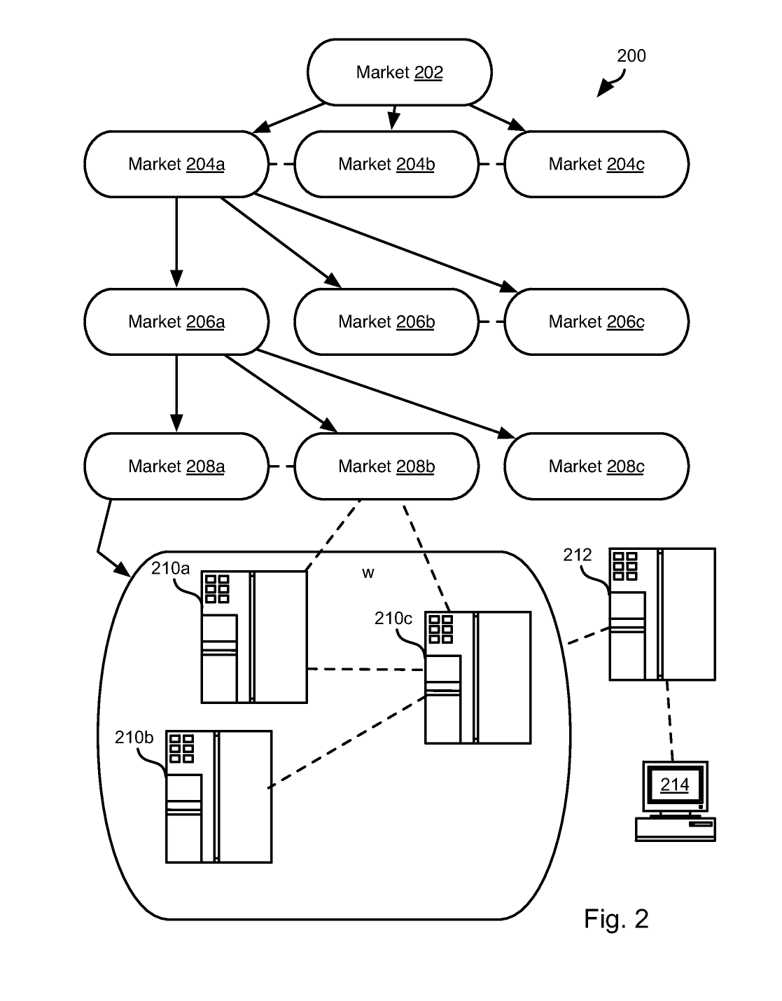

FIG. 2 illustrates an example network environment 200 that may be visualized according to the methods disclosed herein. The network environment may include a plurality of network nodes, each of which may have some or all of the attributes of a computer system 200 and may execute software implementing one or more network services accessible to other nodes of the plurality of nodes or by client computer systems in data communications with nodes of the plurality of nodes.

The plurality of nodes may be organized or grouped into markets. The systems and methods disclosed herein are advantageously used to distribute geographically distributed nodes in a map view that places each node at a location on a map corresponding to its geographic location. In such embodiments, each market may therefore represent a geographic or political region (country, state or province, neighborhood, or some portion of any of these). A market may include other markets. For example, a market that is a country may encompass sub-markets that are defined for states, provinces, or some other geographic definition. Accordingly, a market may include as constituent elements thereof a geographic boundary and/or a collection of markets and/or individual nodes assigned thereto.

Accordingly, as shown in FIG. 2, a network environment 200 may include a top-level market 202, which may, for example, be a country, continent, or some other geographic region. The market 202 may have assigned thereto markets 204a-204c that may represent countries, states, provinces, cities, or other geographic region within the political or geographical boundary defined for market 202. In the same manner, markets 204a-204c may include markets 206a-206c that may each themselves include one or more markets 208a-208c. Any level of nesting of markets within markets may be defined for a network environment 200. Three levels are shown but four or more levels of nested markets may be defined.

Each markets 202-208c may include markets or one or more nodes as constituent elements thereof. For example, markets 208a-208c may include one or more nodes 210a-210c which may represent individual server computers, clusters of computers, personal computing devices (desktop, laptop, tablet, wearable, or other computing devices), or other computing devices. In the diagram of FIG. 2, solid lines with arrows indicate an assignment of one market or node to a market. The dashed lines indicate network connections and/or services provide by one node of a market to a node of another market or between nodes of the same market. For example, the dashed line between market 204a and market 204b indicates that at least one node of market 204a implements a service accessed by a node of market 204b, or vice versa.

Method disclosed herein for visualizing the network environment 200 may be performed by any node 210a-210c of any market or may be implemented by a server system 212 or other computing device that gathers or receives information describing the topology of the network environment and/or the status of the nodes and markets thereof.

An interface or display of a representation of the network environment may be output on the server system 212 or some other computing device 214 (e.g. personal computing device) that is remote from the server system 212.

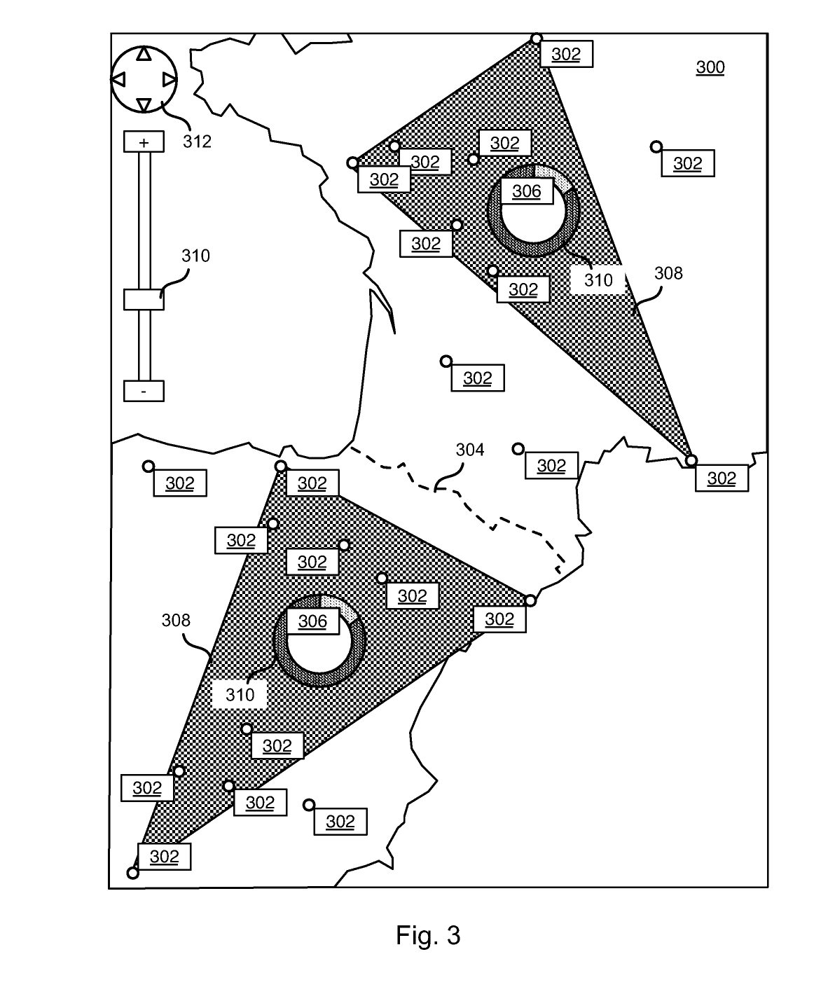

FIG. 3 illustrates an interface 300 that may be displayed on a display device in order to visualize a network environment 200. As is readily apparent, the interface 300 may include an underlying map view that shows labels 302 and locations for cities or other landmarks, borders 304 between countries or other political entities. The map view may also show land masses, bodies of waters, highways, or other entities that may be displayed on a map.

Markets may be displayed on the interface 300. For example, all markets that are viewable in the current map view may be displayed. A viewable market may be a market of which one or more nodes or markets thereof are located within the geographic region represented by the map view being displayed in the interface 300. In some embodiments, only the highest-level market that is viewable may be shown.

Each viewable market may be represented by a label 306 indicating a name of the market, which may correspond to a name of the political or geographical region in which the market is located. Each viewable market may further be represented by a polygon 308 encompassing the nodes of the market. Each polygon 308 may be filled, shaded, or otherwise visually distinguishable from the portion of the map view overlaid thereby. Each polygon 308 may be translucent such that the map view overlaid thereby is viewable therethrough. In particular, the polygon 308 may be a convex hull or minimum convex hull (MCH) that encompasses geographic locations of all of the nodes of a the market represented by the polygon 308, i.e. referenced by the label 306 of the polygon 308. The manner in which the MCH is computed may be according to any method for generating a MCH based on a set of coordinates. The MCH for the nodes of a market may advantageously be computed in advance of any particular request to display some or all of a network environment 200. The MCH may then be stored as vertices of a polygon which may then be easily rendered on a display device when visualization of some or all of the network environment 200. Likewise, the MCH may be recomputed and a polygon representing the MCH (e.g. a list of vertices) may be stored upon modification of the nodes of a market.

This approach advantageously enables display of an extent and status of a network without requiring transmission of the large amounts of data required to represent individual nodes and connections between nodes of a network. Likewise, the use of a polygon corresponding to the MCH enables more information regarding the extent of a network than would be represented by a single icon to represent all of the nodes of a network.

For example, as shown in FIG. 3, each polygon 308 has at its vertices labels 302 for, for example, cities. The polygon 308 therefore indicates the geographic extent of the market represented by the polygon 308. As is also apparent, some labels 302 for cities or other entities are located within the boundaries of the polygons 308 but not at the vertices thereof. Nodes or markets within a market do not define vertices where the algorithm defining the MCH determines that they should not as known in the art of defining an MCH for a set of coordinates.

A polygon 308 may have imposed thereon a status indicator 310 indicating a status or other metadata regarding the market represented by the polygon 308 and corresponding label 306. For example, the status indicator 310 may be include a ring, with the portion of the ring filled in or otherwise shaded according to a particular color or shading indicating a percentage of the nodes and services implemented by nodes of the market that are operational.

The interface 300 may include one or more interfaces for modifying the map view rendered in the display. For example, an interface element 312 may change a zoom level and interface element 310 may pan the map view. Alternatively or additionally, instructions to pan and zoom the map view may be received as keyboard inputs, gestures (swipe, pinch, spreading of fingers, or the like) on a touch screen, or some other input.

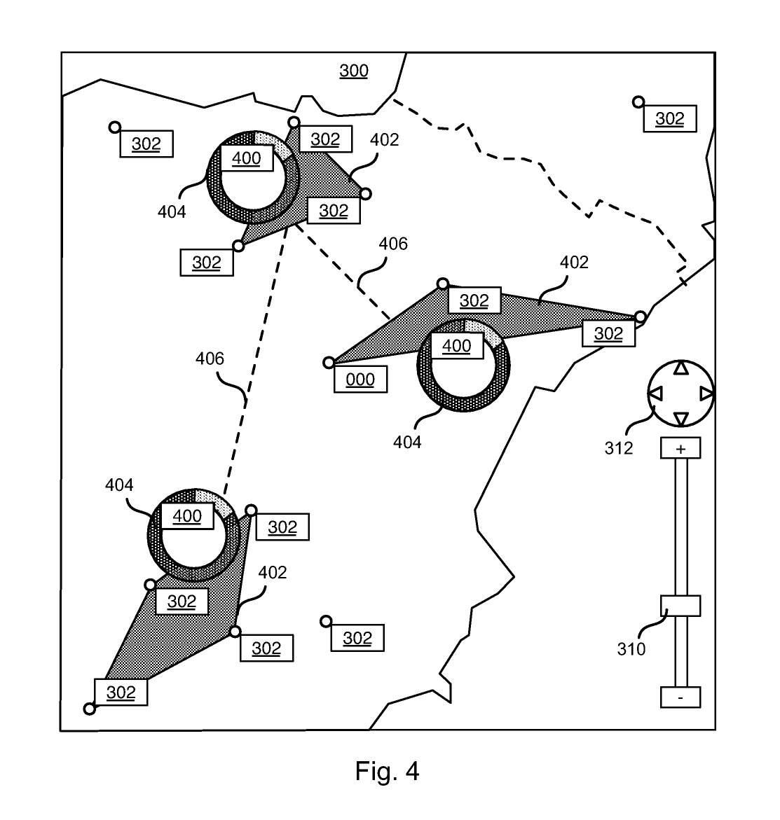

Referring to FIG. 4, upon receiving an instruction to pan, zoom, or otherwise alter the map view, the markets viewable in the altered map view may be identified and polygons, labels, and status indicators may be rendered for the viewable markets in the same manner as for the markets shown in FIG. 3.

For example, FIG. 4 shows a map view following zooming in on the lower market 306 of FIG. 3 or an explicit input received selecting the lower market 306. Inasmuch as only one market is present in the map view, the interface 300 may be rendered by showing constituent markets or nodes of the viewable market rather than the market itself. Accordingly, labels 400 and polygons 402 for constituent markets of a viewable market may be rendered in the interface 300. Likewise status indicators 404 for the viewable markets may be displayed. The labels 400, polygons 402, and status indicators may be displayed based on underlying data for a market in the same manner as described above with respect to FIG. 3. In some embodiments, on receiving a selection o of a market, the map view may be automatically adjusted to approximate the geographic region occupied by the market.

In some embodiments, the decision as to what level of markets to show in the interface 300 may be based on the size of the polygon 308 of a market and the size of the polygons 402 of its sub-markets. For example, if the sub-markets will be of an above-threshold size for a given map view, then the polygons 402 of the sub-markets will be displayed, otherwise the polygon 308 of the higher-level market will be shown. As noted above, the sub-markets of a market may be displayed in response to an selection of the market in a higher level view.

As shown by dotted lines 406, services between nodes of markets may also be represented in the interface 300. In particular, lines 406 or other graphical symbols may be rendered between polygons 402 to indicate network connections or services offered between the markets represented by the polygons 402.

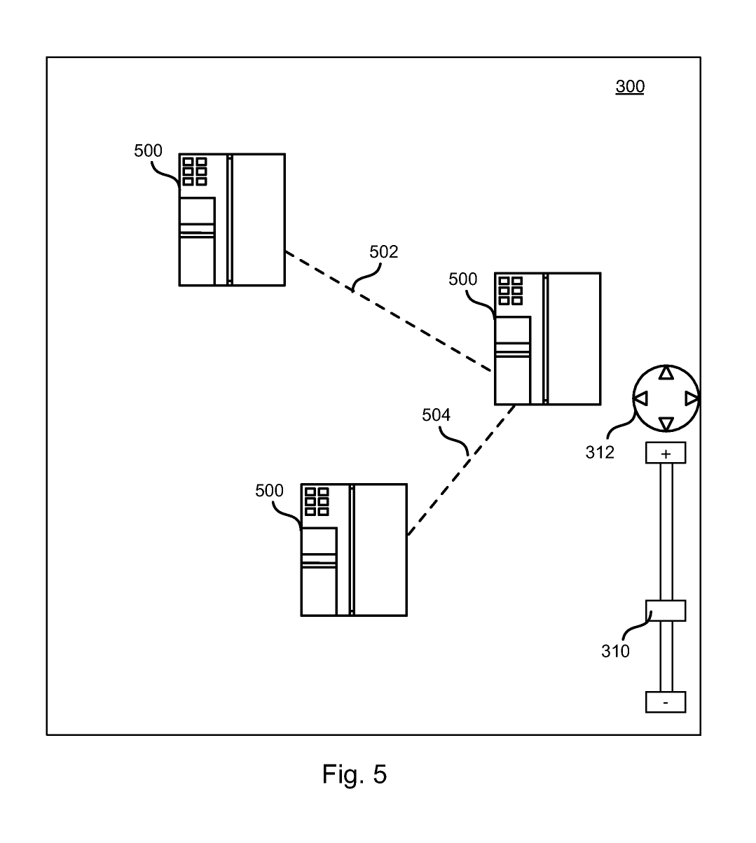

Referring to FIG. 5, in some instances an instruction to zoom or pan may result in a map view in the interface 300 in which only one market is viewable, the one market having no sub-markets as constituent elements thereof, but rather only individual nodes. Accordingly, renderings of symbols 500 for individual nodes of the viewable markets and lines 502 representing network connections and services therebetween may be displayed in the interface 300. Alternatively, upon selection of a market in a view, such as shown in FIG. 4, may invoke display of the constituent nodes or markets of the market as shown in FIG. 5, such as where a market has no sub markets or has both individual nodes not associated with a sub-market thereof and sub-markets assigned thereto.

Upon zooming in the interface 300 of FIG. 5 or selection of a market for more detailed display, constituent nodes of the market being represented as shown in either of FIGS. 3 and 4 may be displayed as shown. Likewise zooming out in the interface 300 of FIG. 3 may result in displaying of the interface as shown in FIG. 2.

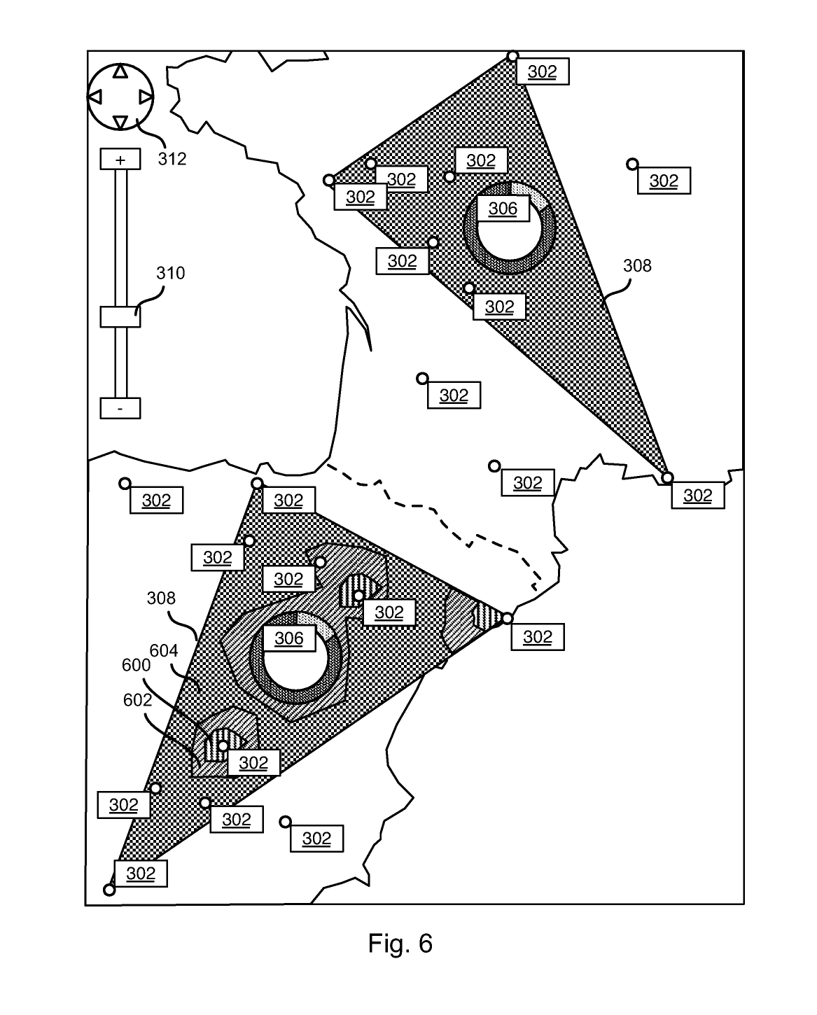

Referring to FIG. 6 in some embodiments, a polygon 308, 402 representing the geographic distribution of nodes of a market may be shaded or otherwise rendered such that a concentration or density of nodes within a particular region encompassed by a polygon is indicated. For example, one fill pattern, color, or shading 600 may indicate a highest number of nodes per unit area; a second fill pattern, color, or shading 602 indicates a lower number of nodes per unit area; and a third fill pattern, color, or shading 604 indicates a still lower number of nodes per unit area, and so on for two, three, or more, including hundreds or thousands of different fill patterns, colors, or shadings each corresponding to a different number of nodes per unit area.

The manner in which regions are selected and assigned a fill pattern, color, or shading may include dividing the polygon into fixed sized regions and assigning each region a fill type according to a number of nodes located within the geographic area represented by that region. After a concentration has been determined for a region, the shading may be smoothed or averaged to avoid abrupt boundaries between regions and indicate a smooth gradient.

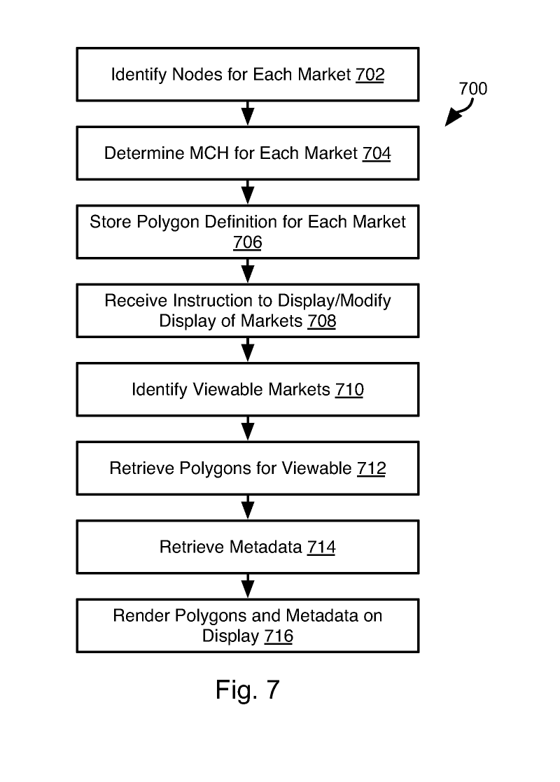

FIG. 7 illustrates a method 700 for rendering an interface 700. The method 700 may be executed upon receiving an instruction to render the interface 700, alter the map view (e.g. a pan or zoom instruction), and/or upon the modification (e.g. addition or removal of nodes) that are represented by a polygon 308, 402 in an interface 300.

The method 700 may include identifying nodes for each market 700; determining 704 a minimum convex hull (MCH) encompassing the geographic locations of nodes of each market; and storing 706 a polygon representing the shape and geographical locations of vertices of the MCH. Steps 702-706 may be executed for multiple levels of markets, as shown in FIG. 2. That is, steps 702-706 may be executed for each market at each level, or a portion of the markets for a portion of the levels.

The method 700 may further include receiving 708 an instruction to display or modify display of one or more markets on a map. In response to this instruction, the method 700 may include identifying 710 markets that are viewable in the portion of a map viewable in an interface. Identifying 710 viewable markets may include identifying either markets for which all nodes thereof are located within the portion of the map viewable in the interface (i.e. have geographic locations within the geographic regions represented by a portion of a map displayed or to be displayed in the interface) or for which at least one node thereof is within the within the portion of the map viewable in the interface.

The method 700 may further include retrieving 712, for each viewable market, the polygon generated at step 706 for the each viewable market. Metadata for the viewable markets may be retrieved 714. Metadata may include any status date representing the state of operation of a node individually or the nodes of a market collectively. As noted above, metadata may indicate a percentage of nodes and/or a percentage of services implemented by nodes of the market that are operating correctly. Metadata may be retrieved from log files for some or all of the nodes of the network environment 200.

The method 700 may then include rendering 716 on a display device a representation of a map in a current map view and superimposing on this map renderings of the polygons for the viewable markets having vertices positioned on the map at positions corresponding to geographic locations of the nodes of the viewable market defining the MCH on which the polygon is based. Labels and metadata for the viewable markets may also be rendered on the display device as shown in any of FIGS. 3 through 6.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for visualizing a network environment including a first plurality of nodes each including at least one computing device providing at least one network service to one or more remote computing devices, the method comprising:
computing, by a computing device, a minimum convex hull (MCH) encompassing geographic locations of the plurality of nodes;
storing, by the computing device, a first polygon corresponding to the minimum convex hull, the first polygon including a listing of vertices;
receiving, by the computing device, an instruction to display the network environment with respect to a field of view; and
in response to receiving the instruction to display the network environment with respect to the field of view, generating, by the computing device, a rendering of the first polygon on a display device with a label identifying the polygon as representing the first plurality of nodes.

2. The method of claim 1, further comprising:
determining a concentrations of nodes of the first plurality of nodes within a geographic region occupied by the geographic locations of the first plurality of nodes;
shading the rendering of the polygon such that variations in shading of the rendering of the first polygon correspond to variations in the concentrations of nodes of the first plurality of nodes within the geographic region.

3. The method of claim 1, further comprising rendering on the rendering of the first polygon on the display device metadata indicating a status of the first plurality of nodes.

4. The method of claim 3, wherein the metadata indicates a percentage of services implemented by the first plurality of nodes that are operational.

5. The method of claim 1, further comprising, generate the rendering of the first polygon on a map such that vertices of the polygon are located on the map at locations corresponding to geographic locations of nodes of the first plurality of nodes corresponding to the vertices.

6. The method of claim 1, wherein the first plurality of nodes are logically associated with a first group, the network environment further comprising a second plurality of node logically associated with a second group, one or more nodes of the second plurality of nodes having a network connection to one or more nodes of the first plurality of nodes; and
wherein the method further comprises:
rendering a rendering of a second polygon on the display device, the second polygon having a shape of an MCH encompassing geographic locations of the second plurality of nodes; and
rendering on the display device a visible symbol extending between the rendering of the first polygon and the rendering of the second polygon, the visible symbol representing the network connection between the one or more nodes of the second plurality of nodes and the one or more nodes of the first plurality of nodes.

7. The method of claim 1, wherein the first plurality of nodes include a plurality of groups of nodes;
wherein the method further comprises:
receiving, by the computing device, selection of the rendering of the first polygon;
in response to receiving the selection of the rendering of the first polygon, retrieving, by the computing device, group polygons for each group of the portion of the plurality of groups, each group polygon corresponding to an MCH encompassing geographic locations of nodes belonging to the group of the portion of the plurality of groups corresponding to the each group polygon; and
generating, by the computing device, renderings of the group polygons on the display device.

8. A system comprising:
a computer system comprising one or more processing devices and one or more memory devices in data communication with the one or more processing devices, the one or more memory devices storing executable and operational data effective to cause the one or more processing devices to:
receiving data describing a network environment including a first plurality of nodes each including at least one computing device providing at least one network service to one or more remote computing devices;
compute a minimum convex hull (MCH) encompassing geographic locations of the plurality of nodes;
store a first polygon corresponding to the minimum convex hull, the first polygon including a listing of vertices;
receive an instruction to display the network environment with respect to a field of view; and
in response to receiving the instruction to display the network environment with respect to the field of view, generate a rendering of the first polygon on a display device with a label identifying the polygon as representing the first plurality of nodes.

9. The system of claim 8, wherein the executable and operational data further effective to cause the one or more processors to:
determine a concentrations of nodes of the first plurality of nodes within a geographic region occupied by the geographic locations of the first plurality of nodes; and
shade the rendering of the polygon such that variations in shading of the rendering of the first polygon correspond to variations in the concentrations of nodes of the first plurality of nodes within the geographic region.

10. The system of claim 8, wherein the executable and operational data further effective to cause the one or more processors to render on the rendering of the first polygon on the display device metadata indicating a status of the first plurality of nodes.

11. The system of claim 10, wherein the metadata indicates a percentage of services implemented by the first plurality of nodes that are operational.

12. The system of claim 8, wherein the executable and operational data further effective to cause the one or more processors to generate the rendering of the first polygon on a map such that vertices of the polygon are located on the map at locations corresponding to geographic locations of nodes of the first plurality of nodes corresponding to the vertices.

13. The system of claim 8, wherein the first plurality of nodes are logically associated with a first group, the network environment further comprising a second plurality of node logically associated with a second group, one or more nodes of the second plurality of nodes having a network connection to one or more nodes of the first plurality of nodes; and
wherein the executable and operational data further effective to cause the one or more processors to:
render a rendering of a second polygon on the display device, the second polygon having a shape of an MCH encompassing geographic locations of the second plurality of nodes; and
render on the display device a visible symbol extending between the rendering of the first polygon and the rendering of the second polygon, the visible symbol representing the network connection between the one or more nodes of the second plurality of nodes and the one or more nodes of the first plurality of nodes.

14. The system of claim 8, wherein the first plurality of nodes include a plurality of groups of nodes;
wherein the executable and operational data further effective to cause the one or more processors to:
receive a selection of the rendering of the first polygon;
in response to receiving selection of the rendering of the first polygon, retrieve group polygons for each group of the portion of the plurality of groups, each group polygon corresponding to an MCH encompassing geographic locations of nodes belonging to the group of the portion of the plurality of groups corresponding to the each group polygon; and
generate renderings of the group polygons on the display device.

15. A system comprising:
a network environment including a first plurality of nodes each including at least one computing device providing at least one network service to one or more remote computing devices;
a computer system comprising one or more processing devices and one or more memory devices in data communication with the one or more processing devices, the one or more memory devices storing executable and operational data effective to cause the one or more processing devices to:
receiving data describing the network environment;
compute a minimum convex hull (MCH) encompassing geographic locations of the plurality of nodes;
store a first polygon corresponding to the minimum convex hull, the first polygon including a listing of vertices;
receive an instruction to display the network environment with respect to a field of view; and
in response to receiving the instruction to display the network environment with respect to the field of view, generate a rendering of the first polygon on a display device with a label identifying the polygon as representing the first plurality of nodes.

16. The system of claim 15, wherein the executable and operational data further effective to cause the one or more processors to:
determine a concentrations of nodes of the first plurality of nodes within a geographic region occupied by the geographic locations of the first plurality of nodes; and
shade the rendering of the polygon such that variations in shading of the rendering of the first polygon correspond to variations in the concentrations of nodes of the first plurality of nodes within the geographic region.

17. The system of claim 15, wherein the executable and operational data further effective to cause the one or more processors to render on the rendering of the first polygon on the display device metadata indicating a status of the first plurality of nodes.

18. The system of claim 15, wherein the executable and operational data further effective to cause the one or more processors to generate the rendering of the first polygon on a map such that vertices of the polygon are located on the map at locations corresponding to geographic locations of nodes of the first plurality of nodes corresponding to the vertices.

19. The system of claim 15, wherein the first plurality of nodes are logically associated with a first group, the network environment further comprising a second plurality of node logically associated with a second group, one or more nodes of the second plurality of nodes having a network connection to one or more nodes of the first plurality of nodes; and
wherein the executable and operational data further effective to cause the one or more processors to:
render a rendering of a second polygon on the display device, the second polygon having a shape of an MCH encompassing geographic locations of the second plurality of nodes; and
render on the display device a visible symbol extending between the rendering of the first polygon and the rendering of the second polygon, the visible symbol representing the network connection between the one or more nodes of the second plurality of nodes and the one or more nodes of the first plurality of nodes.

20. The system of claim 15, wherein the first plurality of nodes include a plurality of groups of nodes;
wherein the executable and operational data further effective to cause the one or more processors to:
receive a selection of the rendering of the first polygon;
in response to receiving the selection of the rendering of the first polygon, retrieve group polygons for each group of the portion of the plurality of groups, each group polygon corresponding to an MCH encompassing geographic locations of nodes belonging to the group of the portion of the plurality of groups corresponding to the each group polygon; and
generate renderings of the group polygons on the display device.
